(19) United States
(12) Patent Application Publication
(10) Pub. No.: US 2026/0255173 A1
(43) Pub. Date: Aug. 27, 2026

(54) DATA SYSTEM SLICING FOR USER APPLICATIONS

(71) Applicant: T-MOBILE INNOVATIONS LLC, Overland Park, KS (US)

(72) Inventors: George Jason Schnellbacher, Leawood, KS (US); Joao Carlos Osorio Gouvea Teixeira de Magalhaes, Shawnee, KS (US)

(21) Appl. No.: 19/061,475

(22) Filed: Feb. 24, 2025

(51) Int. Cl. H04W 12/37; H04W 12/069; H04W 48/16

(52) U.S. Cl. CPC H04W 12/37; H04W 12/069; H04W 48/16

(57) ABSTRACT

A data system authorizes a user application to use a data communication slice. The data system determines a user application indicator for the user application. The data system exchanges user application data for the user application between a user device and the data communication slice based on the application indicator in the user application data. The data communication slice processes the user application data.

### TECHNICAL BACKGROUND

Data systems provide data services to user devices like phones and computers. The data services include internet-access, machine-communications, media-streaming, or some other data product. For example, a fleet of aerial vehicles may use a wireless communication network for vehicle tracking and control. In another example, a team of gamers may use internet access and a gaming server to play an interactive game. The data systems may comprise data system slices that deliver these data services. The data system slices are often optimized for a specific data product like high-reliability for vehicle control and low-latency throughput for gaming.

To access a data system slice, a user device first authenticates itself with the data system. The authenticated user device then requests the data system slice, and the data system checks a user profile for the device to identify an authorization for the data system slice. The data system transfers context to the user device and the data system slice for a data session. The user device and the data system slice then exchange user data. The user device may typically transfer various types of user data for different user applications over the data system slice. The data system slice and the user applications are linked through the user profile of the user device.

In a wireless communication network, a wireless user device stores a secret code and authenticates itself by submitting a hash of the secret code and a random number for verification by the network control-plane. The authenticated wireless user device indicates wireless network slice types, and the network control-plane authorizes wireless network slices for the indicated slice types based on a subscriber profile for the wireless user device. The wireless user device may then use the wireless network slice. The wireless user device executes various user applications, and the wireless user device may use the wireless network slice to exchange the application data. The wireless network slice and the user applications in the wireless user device are linked by the presence of the user applications in the wireless user device and the authorization for the wireless network slice in the subscriber profile for the wireless user device.

### TECHNICAL OVERVIEW

An exemplary data system comprises a control system and a communication system. The control system authorizes a user application to use a data communication slice. The control system determines a user application indicator for the user application. The communication system exchanges user application data for the user application between a user device and the data communication slice based on the application indicator in the user application data. The data communication slice processes the user application data.

An exemplary wireless communication device comprises a device processing system and a wireless communication system. The device processing system authenticates a user application, and in response, determines a user application indicator for the user application. The wireless communication system adds the application indicator to user application data for the user application in response to the authentication. The wireless communication system exchanges the user application data with a wireless network slice based on the application indicator in the user application data. The wireless communication system inhibits exchanges of other application data with the wireless network slice when the other application data does not have the application indicator.

An exemplary method comprises the following operations. Authorize a user application to use a data communication slice. Determine an application indicator for the user application in response to the authorization. Exchange user application data having the user application indicator between a user device and the data communication slice based on the application indicator in the user application data. Inhibit other exchanges of other application data between the user device and the data communication slice that does not have the application indicator.

### DESCRIPTION OF THE DRAWINGS

FIG. 1 illustrates an exemplary data system to authorize user applications to use data communication slices.

FIGS. 2-3 illustrate exemplary operations of the data system to authorize the user applications to use the data communication slices.

FIG. 4 illustrates an exemplary wireless data system having a network Application Programming Interface (API) for an application developer to authorize a user application to use a wireless network slice.

FIG. 5 illustrates an exemplary wireless communication network to authorize user applications to use wireless network slices.

FIG. 6 illustrates an exemplary User Equipment (UE) in the wireless communication network that authorizes the user applications to use the wireless network slices.

FIG. 7 illustrates an exemplary terrestrial 5GNR AN in the wireless communication network that authorizes the user applications to use the wireless network slices.

FIG. 8 illustrates an exemplary Wireless Fidelity (WIFI) AN in the wireless communication network that authorizes the user applications to use the wireless network slices.

FIG. 9 illustrates an exemplary Satellite (SAT) AN and SAT Ground Station (GND) in the wireless communication network that authorizes the user applications to use the wireless network slices.

FIG. 10 illustrates an exemplary Network Function Virtualization Infrastructure (NFVI) in the wireless communication network that authorizes the user applications to use the wireless network slices.

FIG. 11 illustrates an exemplary operation of the wireless communication network to serve a distributed user application using a wireless network slice.

FIG. 12 illustrates an exemplary operation of the wireless communication network to couple a user application to an application server over a wireless network slice.

FIG. 13 illustrates an exemplary operation of the wireless communication network to couple user applications over a wireless network slice.

FIG. 14 illustrates exemplary processing circuitry to authorize a user application to use a network slice.

### DETAILED DESCRIPTION

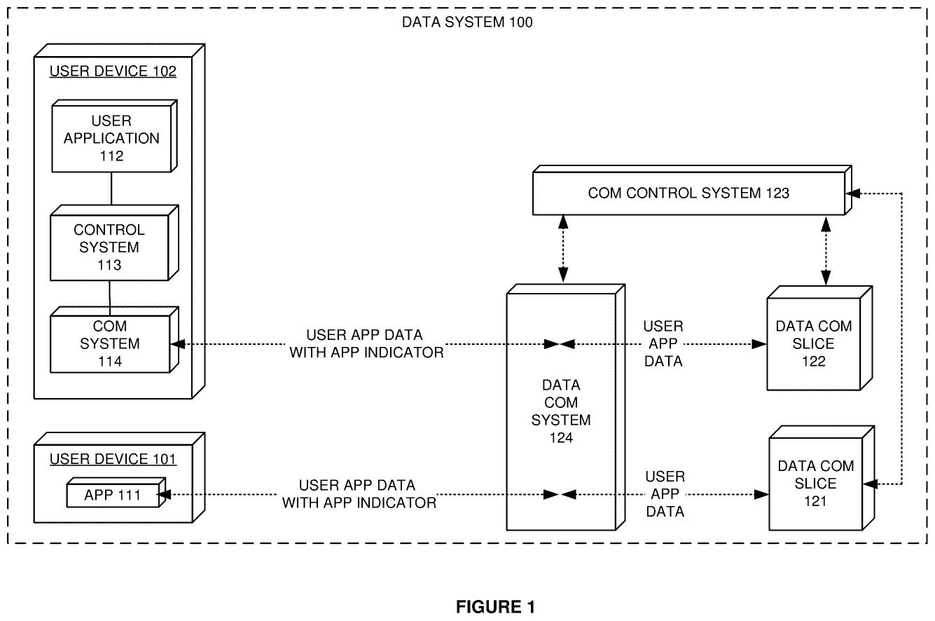

FIG. 1 illustrates exemplary data system 100 to authorize user applications 111-112 to use data communication slices 121-122. Data system 100 comprises user devices 101-102, data communication slices 121-122, communication control system 123, and data communication system 124. User device 101 comprises user application 111, and user device 102 comprises user application 112. User device 102 is also shown with device control system 113 and device communication system 114. User devices 101-102 comprise phones, computers, vehicles, robots, sensors, and/or some other user apparatus with data communication components. User applications 111-112 deliver user services like social networking, media streaming, machine control, environmental monitoring, and/or some other user data product.

Data communication slices 121-122 comprises network elements, application servers, artificial intelligence models, and/or some other computer components that support user applications 111-112 in data system 100. Communication control system 123 comprises management functions, network controllers, artificial intelligence models, and/or some other control-plane network elements. Data communication system 124 comprises access nodes, routers, user-plane functions and/or some other user-plane network elements. In user device 102, device control system 113 comprises operating systems, control modules, artificial intelligence models, and/or some other processing components. Device control system 113 may comprise binary software code that is executed by user device 102 but is controlled by data system 100 and that cannot be decompiled by device 102. The binary software code maintains trust between user device 102 and communication control system 123. Device communication system 114 comprises data processors, transceivers, and/or some other communication components.

In some examples, communication control system 123 authorizes user application 111 to use data communication slice 121. The authorization could be based on subscriber information, device/application authentication, digital certificate, and/or some other information that shows that user application 111 may use slice 121. The authorization could be based on conditions like time, day, user location, network status, and the like. Communication control system 123 determines a user application indicator for user application 111. The application indicator might be a code, hash, Uniform Resource Indicator (URI), Internet Protocol (IP) address/port, X.509 certificate, data packet format, and/or some other information that distinguishes the user data for user application 111. Communication control system 123 typically associates the authentication/authorization of user application 111 with an application identifier like a Uniform Resource Indicator (URI) and/or Internet Protocol (IP) address information, and data communication system 124 exchanges the user application data between user device 101 and data communication slice 121 based on this URI and/or IP address information. Communication control system 123 indicates the user application indicator for user application 111 to user device 101 and data communication system 124. User device 101 exchanges user application data with data communication system 124, and user device 101 adds the application indicator to the user application data that it transfers to data communication system 124. Data communication system 124 exchanges the user application data for user application 111 between user device 101 and data communication slice 121 based on the application indicator in the user application data. Thus, data communication system 124 will not transfer the user application data for user application 111 from user device 101 to data communication slice 121 without detecting this application indicator in the user application data. Data communication slice 121 processes the user application data for user application 111. For example, data communication slice 121 may comprise an Artificial Intelligence (AI) engine that receives prompts from user application 111 and transfers AI results to user application 111. In another example, data communication slice 121 may securely exchange the user application data with a remote application server (not shown) for user application 111.

In some examples, communication control system 123 indicates the user application indicator for user application 111 to data communication slice 121. Data communication slice 121 adds the application indicator to the user application data that it transfers to data communication system 124. In these examples, data communication system 124 will not transfer the user application data for user application 111 from data communication slice 121 to user device 101 without detecting this application indicator in the user application data.

In some examples, device control system 113 authorizes user application 112 to use data communication slice 122. The authorization could be based on signaling from communication control system 123, application authentication, digital certificate, and/or some other information that shows that user application 112 may use slice 122. The authorization could be based on conditions like time, day, user location, network status, and the like. Device control system 113 determines a user application indicator for user application 112. The application indicator might be a code, hash, URI, IP address/port, X.509 certificate, data packet format, and/or some other information that distinguishes user data for user application 112. Device control system 113 typically associates the authentication/authorization of user application 112 with an application identifier like a URI and/or IP address information, and data communication system 124 exchanges the user application data between user device 102 and data communication slice 122 based on this URI and/or IP address information. Communication control system 123 may indicate the user application indicator for user application 112 to device control system 113. Device control system 113 indicates the user application identifier to device communication system 114. Device communication system 114 exchanges user application data with data communication system 124, and device communication system 114 adds the application indicator for user application 112 to the user application data that it transfers to data communication system 124. Data communication system 124 exchanges the user application data for user application 112 between user device 102 and data communication slice 122 based on the application indicator in the user application data. Thus, data communication system 124 will not transfer the user application data for user application 112 from user device 102 to data communication slice 122 without detecting this application indicator in the user application data. Data communication slice 122 processes the user application data for user application 112. For example, data communication slice 122 may provide augmented reality to user application 112.

In some examples, communication control system 123 indicates the user application indicator for user application 112 to data communication slice 122. Data communication slice 122 adds the application indicator to the user application data for user application 112 that it transfers to data communication system 124. Data communication system 124 will not transfer the user application data for user application 112 from data communication slice 122 to user device 102 without detecting this application indicator in the user application data.

In some examples, the format of the user application data comprises at least a part of the application indicator. The format comprises a data header and data payload the each have data fields. The location, size, and content of these data fields can be used to create a user application signature that adequately indicates the user application. User devices 101-102 and data communication system 124 transfer the user application data that has the proper format and block the user application data that has the wrong format.

In some examples, communication control system 123 authenticates user device 101. Communication control system 123 transfers signaling with instructions for user device 101 to data communication system 124 for communications between user device 101 and data communication slice 121. Data communication system 124 will not exchange the user application data for user application 111 between user device 101 and data communication slice 121 without both the device authentication. Thus, the exchange of the user application data requires the authentication of both user device 101 and user application 111 in these examples.

In some examples, communication control system 123 generates charging information for usage of user applications 111-112 based on the exchange of the user application data. For example, device control system 113, data communication system 124, and/or data communication slices 121-122 may generate usage data that characterizes the user application data exchanges (data amount, transfer time, endpoints, formats, URI, IP address information) between user applications 111-112 and data communication slices 121-122. Communication control system 123 converts the usage data into monetary charges for the usage of user applications 111-112, data communication system 124, and/or data communication slices 121-122.

In some examples, communication control system 123 receives an Application Programming Interface (API) call for user application 112 from a user application system (not shown), and in response, transfers authentication information for the user application to the user application system. For example, a developer computer may call an API on communication control system 123 for data communication slice 122, and communication control system 123 responds to the API call with authentication information for user application 112 like a digital certificate or secret code. The developer computer adds the authentication information to user application 112 and transfers user application 112 to user device 102. Device control system 113 and/or communication control system 123 authorize user application 112 to use data communication slice 121 based on this authentication information in user application 112. Application authorization conditions like time, day, user location, network status, and the like may be set through this API procedure.

In some examples, user devices 101-102 and data communication system 124 may wirelessly communicate using wireless protocols like Wireless Fidelity (WIFI), Fifth Generation New Radio (5GNR), Long Term Evolution (LTE), Low-Power Wide Area Network (LP-WAN), Near-Field Communications (NFC), Code Division Multiple Access (CDMA), Frequency Division Multiple Access (FDMA), Time Division Multiple Access (TDMA), satellite data communications and/or some other wireless protocol. User devices 101-102, slices 121-122, and systems 123-124 comprise microprocessors, software, memories, transceivers, bus circuitry, and/or some other data processing components. The microprocessors comprise Digital Signal Processors (DSP), Central Processing Units (CPU), Graphical Processing Units (GPU), Application-Specific Integrated Circuits (ASIC), and/or some other data processing hardware. The memories comprise Random Access Memory (RAM), flash circuitry, disk drives, and/or some other type of data storage. The memories store software like operating systems, utilities, protocols, applications, and functions. The microprocessors retrieve the software from the memories and execute the software to drive the operation of data system 100 as described herein.

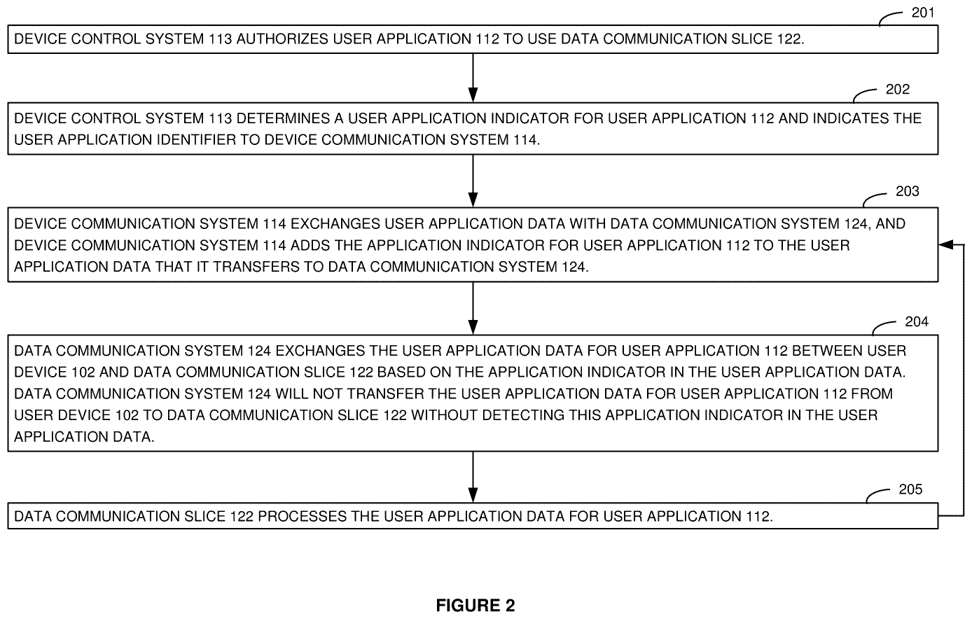

FIG. 2 illustrates an exemplary operation of data system 100 to authorize user application 112 to use data communication slice 122. The operation may differ in other examples. Device control system 113 authorizes user application 112 to use data communication slice 122 (201). Device control system 113 determines a user application indicator for user application 112 and indicates the user application identifier to device communication system 114 (202). Device communication system 114 exchanges user application data with data communication system 124, and device communication system 114 adds the application indicator for user application 112 to the user application data that it transfers to data communication system 124 (203). Data communication system 124 exchanges the user application data for user application 112 between user device 102 and data communication slice 122 based on the application indicator in the user application data (204). Data communication system 124 will not transfer the user application data for user application 112 from user device 102 to data communication slice 122 without detecting this application indicator in the user application data (204). Data communication slice 122 processes the user application data for user application 112 (205). The operation repeats (203) and new authorizations (201) and/or new application identifiers (202) are typically implemented over time.

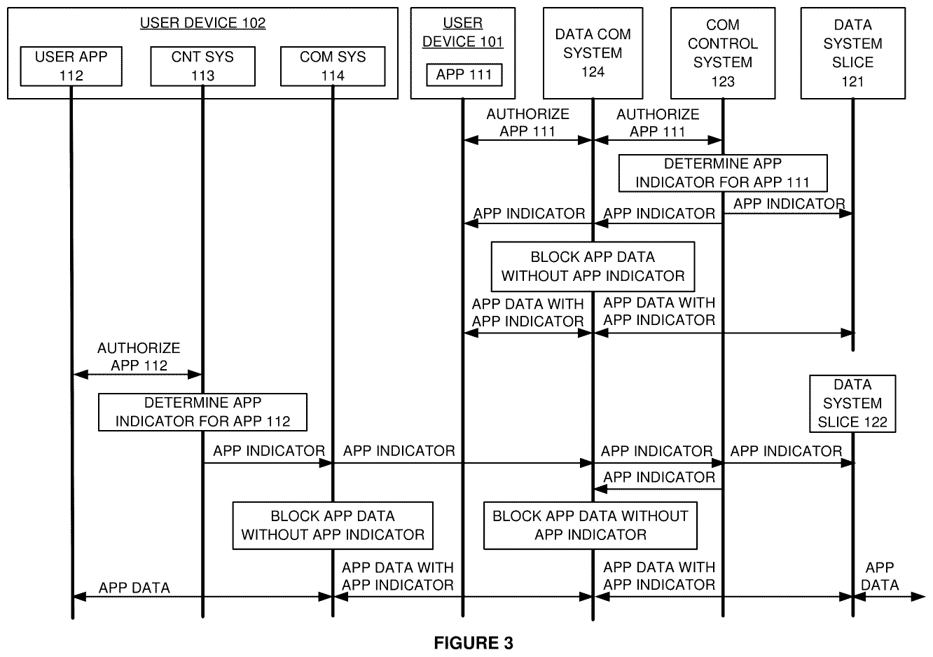

FIG. 3 illustrates an exemplary operation of data system 100 to authorize user applications 111-112 to use data communication slices 121-122. The operation may differ in other examples. User device 101 and communication control system 123 interact to authorize user application 111 to use data system slice 121. Communication control system 123 determines an application identifier for user application 111 in response to the authorization. Communication control system 123 transfers the application indicator to data system slice 121. Communication control system 123 transfers the application indicator to data communication system 124. Data communication system 124 transfer the application identifier to user device 101. Data communication system 124 blocks user application data for user application 111 between user device 101 and data communication slice 121 when this application identifier is not detected in the user application data. User device 101 and data communication slice 121 add the application indicator to their user application data and exchange this user application data over data communication system 124 based on the application indicator. Data communication slice 121 processes the user application data for user application 111.

In user device 102, device control system 113 and user application 112 interact to authorize user application 112 to use data system slice 122. Device control system 113 determines an application identifier for user application 112 in response to the authorization. Device control system 113 transfers the application indicator for user application 112 to communication control system 123 over communication systems 114 and 124. Communication control system 123 transfers the application indicator to data system slice 122 and data communication system 124. Device communication system 114 and data communication system 124 block user application data for user application 112 between user device 102 and data communication slice 122 when this application identifier is not detected in the user application data. Device communication system 114 exchanges application data with user application 112. Data communication slice 122 exchanges application data with a remote application server (not shown). Data communication system 114 and data system slice 122 add the application indicator to their user application data and exchange this user application data over data communication system 124 based on the application indicator.

Advantageously, data system 100 efficiently authorizes user applications 111-112 to use data communication slices 121-122. Moreover, data system 100 effectively links user applications 111-112 with data communication slices 121-122 without necessarily requiring the user profile for user devices 101-102.

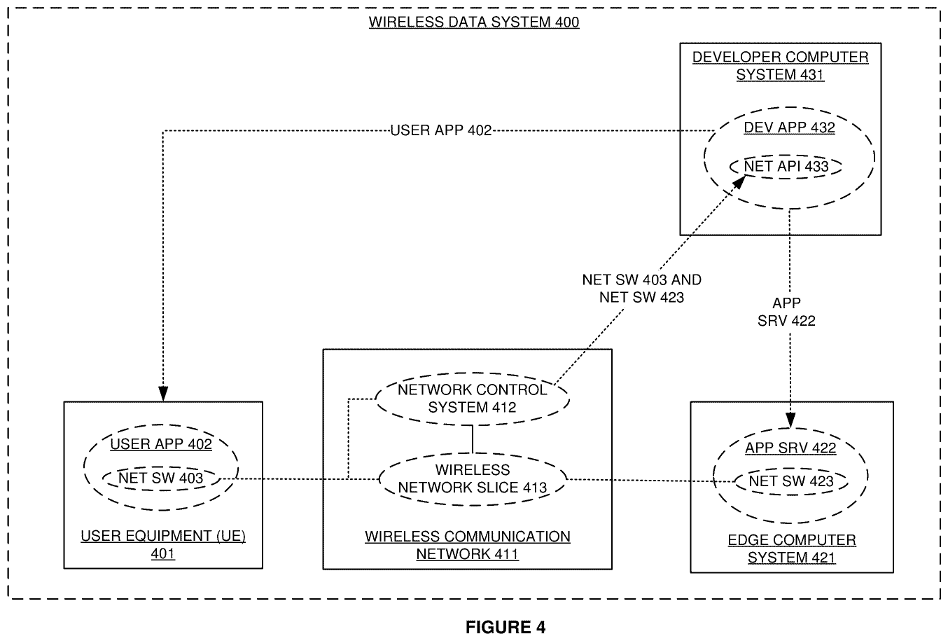

FIG. 4 illustrates exemplary wireless data system 400 having network Application Programming Interface (NET API) 433 for an application developer to authorize user application 403 to use wireless network slice 413. Wireless data system 400 comprises an example of data system 100, although system 100 may differ. Wireless data system 400 comprises User Equipment (UE) 401, wireless communication network 411, edge computer system 421, and developer computer system 431. UE 401 comprises user application (APP) 402 which includes network software (NET SW) 403. Wireless communication network 411 comprises network control system 412 and wireless network slice 413. Edge computer system 421 comprises application server (APP SRV) 422 which includes network software 423. Developer computer system 431 comprises developer application (DEV APP) 432 which includes network API 433.

User application 402 and application server 422 interact over wireless network slice 413 to deliver a data service to UE 401. For example, user application 402 and application server 422 may comprise an Augmented Reality (AR) system, and wireless network slice 413 may comprise a low-latency communication link between user application 402 and application server 422. Network software 403 and 423 comprises executable binary code that cannot be decompiled or effectively modified. Network software 403 and network software 423 each has a secret identification code for authentication.

In developer computer system 431, developer application 432 is developing user application 402 and corresponding application server 432. To link user application 402 and corresponding application server 432 over wireless network slice 413, developer application 432 calls network API 433 to obtain network software 403 and network software 423 for use with wireless network slice 413. Developer application 432 sets a condition for user application 402 to use wireless network slice 413—like a geographic restriction. Network control system 412 sets the condition and transfers network software 403 and network software 423 to developer application 432 over network API 433. Developer application 424 adds network software 403 to user application 402 and adds network software 423 to application server 422. Developer application 424 transfer user application 402 for delivery to UE 401—typically over an app store and possibly using wireless communication network 411.

In UE 401, user application 402 transfers a digital certificate to network software 403. Network software 403 validates the digital certificate to authorize user application 402 to use wireless network slice 413. User application 402 generates user application data and transfers the user application data to network software 403. Network software 403 adds an application identifier to the user application data. In this example, the application identifier comprises an application identifier, a random number, and a hash of the random number and the secret identification code in network software 403. Network software 403 transfers the user application data with the application identifier in packet headers to wireless network slice 413 over wireless communication network 411. Wireless communication network 411—and possibly wireless network slice 413—check the user application data for the user application indicator and apply the geographic condition. Since the user application indicator is present and UE 401 is within the restricted geographic area, wireless network slice 413 transfers the user application data to edge computer system 421. In edge computer system 421, network software 423 removes the application indicator from the user application data and delivers the user application data from user application 402 to application server 422.

User application 402 and application server 422 interact over wireless network slice 413 to deliver a service like geographically-restricted AR. In some examples, UE 401 may need to first authenticate with wireless communication network 411 although that is not required in other examples since user application 402 is authorized to use wireless network slice 413. In some examples, edge computer system 421 may need to first authenticate with wireless communication network 411 although that is not required in other examples since application server 422 is authorized to use wireless network slice 413.

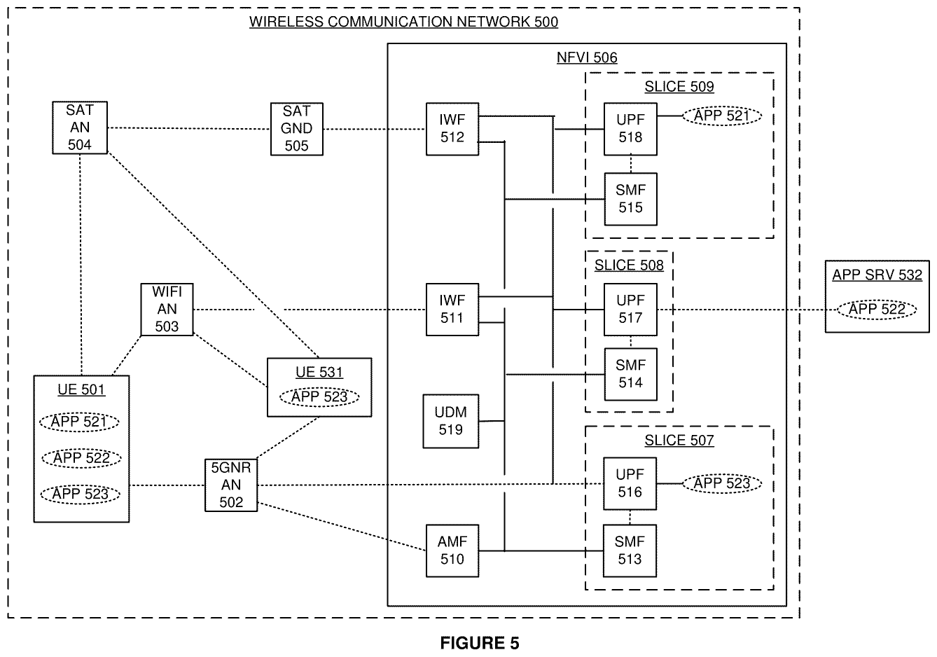

FIG. 5 illustrates an exemplary wireless communication network 500 to authorize user applications 521-523 to use wireless network slices 507-509. Wireless communication network 500 comprises an example of data systems 100 and 400, although systems 100 and 400 may differ. Wireless communication network 500 comprises User Equipment (UEs) 501 and 531, Fifth Generation New Radio (5GNR) AN 502, Wireless Fidelity (WIFI) AN 503, earth satellite (SAT) AN 504, satellite ground station (SAT GND) 505, and Network Function Virtualization Infrastructure (NFVI) 506. NFVI 506 comprises wireless network slices 507-509, Access and Mobility Management Function (AMF) 510, Interworking Functions (IWFs) 511-512, and Unified Data Management (UDM) 519. Wireless network slice 507 comprises Session Management Function (SMF) 513, User Plane Function (UPF) 516, and user application 523. Wireless network slice 508 comprises SMF 514 and UPF 517. Wireless network slice 509 comprises SMF 515, UPF 518, and user application 521. UE 501 comprises user applications 521-523. UE 531 comprises user application 523. Application server (APP SRV) 532 comprises user application 522. User application 521 is distributed between UE 501 and slice 509. User application 522 is distributed between UE 501 and application server 532. User application 523 is distributed between UE 501, UE 531, and slice 507.

In a first example, UE 501 registers with AMF 510 over WIFI AN 503 and IWF 511, and AMF 510 retrieves subscriber information from UDM 519 during this process. AMF 501 authenticates UE 501 and will not provide non-emergency services until authentication is successful. After authentication, UE 501 requests user application 521 and slice 509. The subscriber information indicates that user application 521 and slice 509 are authorized for UE 501. AMF 510 selects SMF 515 for slice 509, and AMF 510 and SMF 515 interact to develop UE context for user application 521 like network addresses and service quality. AMF 510 also determines an application indicator for user application 521 and slice 509 like a session code and the network addresses. AMF 510 adds the application indicator to the UE context. SMF transfers the UE context to UPF 518 and to user application 521. AMF 510 transfers the UE context to IWF 511. AMF 510 transfers the UE context to UE 501 over IWF 511 and WIFI AN 503. UE 501 adds the application indicator for user application 521 to application data from user application 521. UE 501 transfers the application data to IWF 511 over WIFI AN 503. Since this application data has the appropriate application indicator, IWF 511 transfers the application data to UPF 518 in slice 509. When IWF 511 receives application data that does not have the proper application indicator, IWF 511 does not transfer the application data to UPF 518. UPF 518 transfers the application data to user application 521 in slice 509. In other examples, UPF 518 could filter the user application data based on the application indicator in the manner of IWF 511. In slice 509, user application 521 adds its application indicator to application data for UE 501 and transfers the application data to UPF 518. Since the user data has the appropriate application indicator, UPF 518 transfers the application data to UE 501 over IWF 511 and WIFI AN 503. When UPF 518 receives application data that does not have the proper application indicator, then UPF 518 does not transfer the application data to IWF 511.

In a second example, user application 522 in UE 501 has a digital certificate for access to slice 508. UE 501 registers with AMF 510 over 5GNR AN 502 and includes the digital certificate from user application 522. AMF 510 decodes the digital certificate to select slice 508 and SMF 514. In response to the valid digital certificate, AMF 510 does not have to perform the typical authentication although it could. AMF 510 and SMF 514 interact to develop UE context for user application 522 like network addresses and service quality. AMF 510 also determines an application indicator for user application 522 and slice 508 like a session code and the network addresses. AMF 510 adds the application indicator to the UE context. SMF 514 transfers the UE context to UPF 517. AMF 510 transfers the UE context to 5GNR AN 502. AMF 510 transfers the UE context to UE 501 over 5GNR AN 502. UE 501 adds the application indicator for user application 522 to application data from user application 522. UE 501 transfers the application data to 5GNR AN 502. Since this application data has the appropriate application indicator, 5GNR AN 502 transfers the application data to UPF 517 in slice 508. When 5GNR AN 502 receives application data that does not have the proper application indicator, then 5GNR AN 502 does not transfer the application data to UPF 517. UPF 517 transfers the application data to user application 522 in application server 532. In application server 532, user application 522 transfers application data to UE 501 over UPF 517 and 5GNR AN 502. In this example, the application indicator is not required for application data from application server 532 where other security measures are used.

In a third example, user application 523 in slice 507 transfers its application indicators to SMF 513 which transfers the application indicators to AMF 510. In this example, the application indicators comprises temporary codes for user application 523. AMF 510 transfers the temporary codes to SAT AN 504 over IWF 512 and SAT GND 505. Other SAT ANs could be used in a like manner but are omitted for clarity. In UE 501, user application 523 is configured with one of the temporary codes—perhaps receiving it from user application 523 in slice 507 during a prior session. In UE 531, user application 523 is configured with another one of the temporary codes—perhaps receiving it from user application 523 in slice 507 during a prior session. UE 501 and UE 531 connect with SAT AN 504 and transfer their user application data that has their temporary codes. SAT AN 503 detects temporary codes, and in response, transfers the user application data to user application 523 in slice 507 over SAT GND 505, IWF 512, and UPF 516. Distributed user application 523 now executes in UE 501, UE 531, and slice 507 over these two satellite links. Distributed user application 523 in slice 507 securely issues new temporary codes to AMF 510, UE 501, and UE 531 during the session for use with subsequent communication links.

In a fourth example, UPFs 516-518 monitor their usage and generate usage data that indicates network addresses, data amount, data type, time, date, and the like. UPFs 516-518 could also add application indications to the usage data. UPFs 516-518 transfer the usage data to SMFs 513-515. SMFs 513-515 may add the application indications to the usage data. SMFs 513-515 transfer the usage data with application indications to a charging function (not shown) that generates Call Detail Records (CDRs) based on the usage data and transfers the CDRs to a billing system. The billing system generates monetary charges based on the CDRs. The billing system could allocate the monetary charges to user applications 521-523 based on the application indications in the CDRs. A host of a user application may then pay for the slice usage by their hosted user applications.

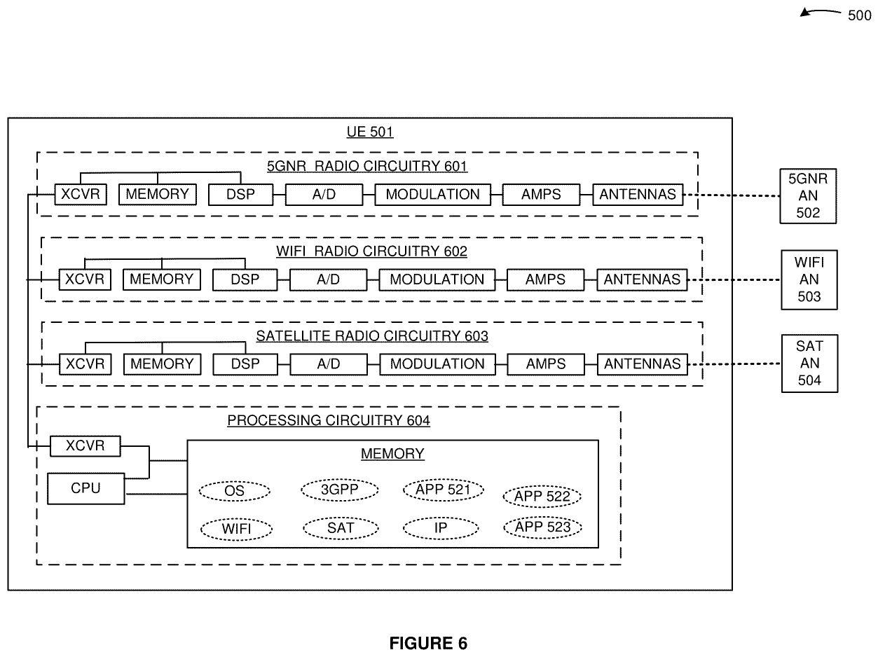

FIG. 6 illustrates an exemplary User Equipment (UE) 501 in wireless communication network 500 that authorizes user applications 521-523 to use wireless network slices 507-509. UE 501 comprises an example of user devices 101-102, User Equipment (UE) 401, and UE 531, although devices 101-102, UE 401, and UE 531 may differ. UE 501 comprises Fifth Generation New Radio (5GNR) radio circuitry 601, Wireless Fidelity (WIFI) radio circuitry 602, satellite radio circuitry 603, and processing circuitry 604. Radio circuitry 601-603 comprises antennas, amplifiers, filters, modulation, analog-to-digital interfaces, DSPs, memories, and transceivers (XCVRs) that are coupled over bus circuitry. Processing circuitry 604 comprises one or more CPUs, one or more memories, and one or more transceivers that are coupled over bus circuitry. The one or more memories in processing circuitry 604 store software like an Operating System (OS), 3GPP Application (3GPP), WIFI Application (WIFI), Satellite Application (SAT), Internet Protocol Application (IP), and user applications 521-523. The antennas in radio circuitry 601-603 exchange wireless signals with ANs 502-504. Transceivers in radio circuitry 601-603 are coupled to transceivers in processing circuitry 604. In processing circuitry 604, the one or more CPUs retrieve the software from the one or more memories and execute the software to direct the operation of UE 501 as described herein.

In particular, software components in the OS, IP, 3GPP, WIFI, and/or SAT authorize user applications 521-523 for network slices 507-509 and determine the application indicators for user applications 521-523. Software components in the OS, IP, 3GPP, WIFI, and/or SAT add the appropriate application indicators to the application data for user applications 521-523. Software components in the OS, IP, 3GPP, WIFI, and/or SAT may filter the application data based on the appropriate application indicators for user applications 521-523. In some examples, the OS or a Radio Resource Control (RRC) in the 3GPP application authorize user applications 521-523 for network slices 507-509 and determines the application indicators for user applications 521-523. In some examples, a Media Access Control (MAC) in the 3GPP, WIFI, and SAT applications adds the appropriate application indicators to the application data for user applications 521-523. In some cases, the MAC also filters out user application data that is missing the proper application indicators.

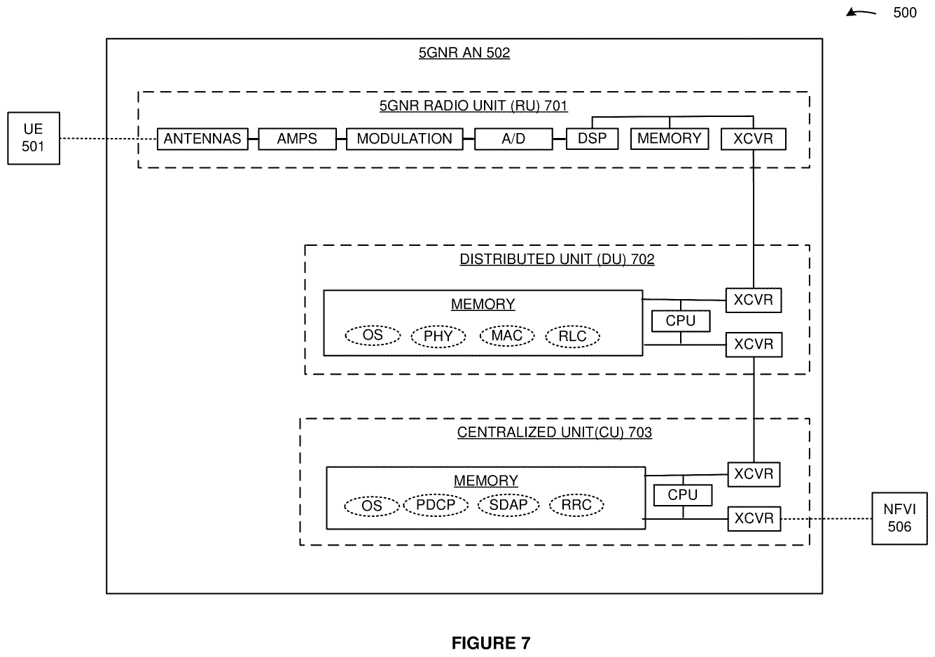

FIG. 7 illustrates exemplary 5GNR AN 502 in wireless communication network 500 that authorizes user applications 521-523 to use wireless network slices 507-509. 5GNR AN 502 comprises an example of communication system 124 and wireless communication network 411, although system 124 and network 411 may differ. 5GNR AN 502 comprises 5GNR Radio Unit (RU) 701, Distributed Unit (DU) 702, and Centralized Unit (CU) 703. 5GNR RU 701 comprises antennas, amplifiers, filters, modulation, analog-to-digital interfaces, DSP, memory, radio applications, transceivers, and power supply (PWR) that are coupled over bus circuitry. DU 702 comprises memory, CPU, transceivers, and power supply that are coupled over bus circuitry. The memory in DU 702 stores operating system and 5GNR network applications for Physical Layer (PHY), Media Access Control (MAC), and Radio Link Control (RLC). CU 703 comprises memory, CPU, transceivers, and power supply that are coupled over bus circuitry. The memory in CU 703 stores an operating system and 5GNR network applications for Packet Data Convergence Protocol (PDCP), Service Data Adaption Protocol (SDAP), Radio Resource Control (RRC), and power control (PWR). The antennas in 5GNR RU 701 are wirelessly coupled to UEs 501 over 5GNR links. Transceivers in 5GNR RU 701 are coupled to transceivers in DU 702. Transceivers in DU 702 are coupled to transceivers in CU 703. Transceivers in CU 703 are coupled to transceivers in NFVI 506. The DSP and CPU in RU 701, DU 702, and CU 703 execute the radio applications, operating systems, and network applications to exchange data and signaling between UE 501 and NFVI 506 as described herein. In particular, the RRC in CU 703 may receive application indicators from NFVI 506. The MAC in DU 702 may filter the application data based on the appropriate application indicators.

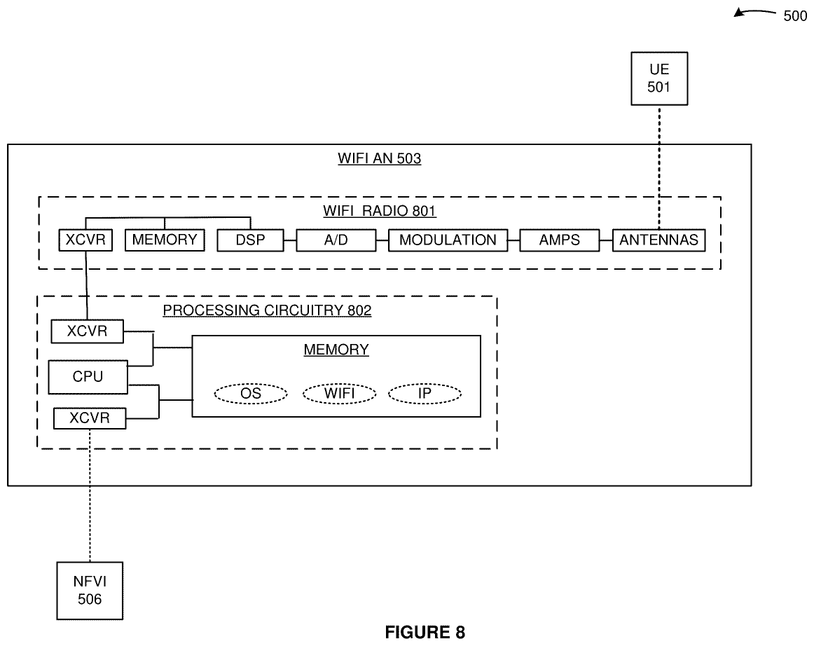

FIG. 8 illustrates an exemplary Wireless Fidelity (WIFI) AN 403 in wireless communication network 500 that authorizes user applications 521-523 to use wireless network slices 507-509. WIFI AN 503 comprises an example of communication system 124 and wireless communication network 411, although system 124 and network 411 may differ. WIFI AN 503 comprises WIFI radio 801 and processing circuitry 802. Radio 801 comprises antennas, amplifiers, filters, modulation, analog-to-digital interfaces, DSPs, memories, transceivers, and power supply that are coupled over bus circuitry. Processing circuitry 802 comprises one or more CPUs, one or more memories, and one or more transceivers that are coupled over bus circuitry. The one or more memories in processing circuitry 802 store software like an Operating System (OS), WIFI application (WIFI), and IP application (IP). The antennas in WIFI radio 801 exchange WIFI signals with UE 501. Transceivers in radio 801 are coupled to transceivers in processing circuitry 802. Transceivers in processing circuitry 802 are coupled to transceivers in NFVI 506. In processing circuitry 802, the one or more CPUs retrieve the software from the one or more memories and execute the software to exchange data and signaling between UE 501 and NFVI 506 as described herein. In particular, the WIFI and/or IP applications may receive application indicators from NFVI 506 and filter out user application data that is missing the proper application indicators.

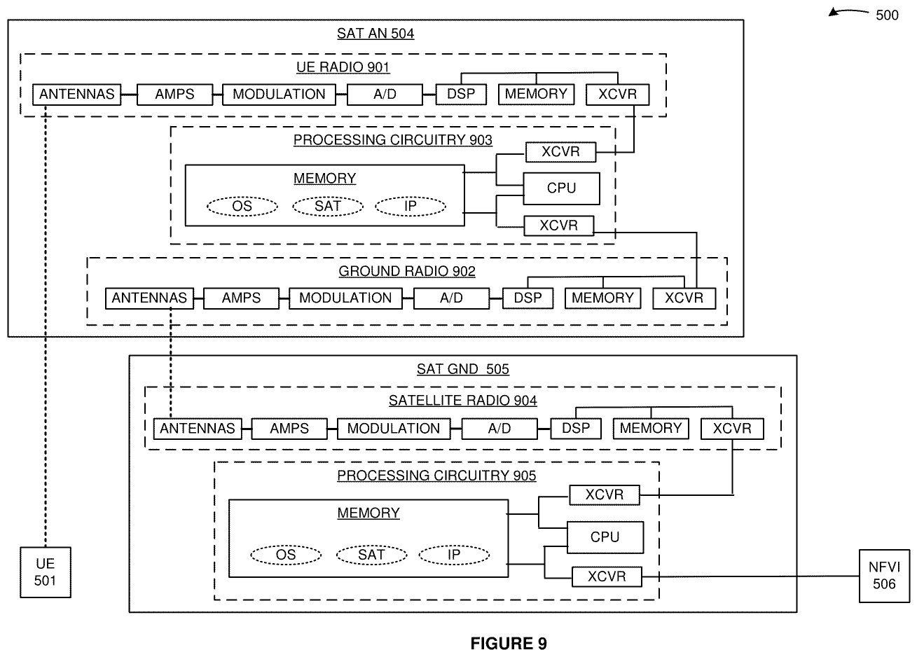

FIG. 9 illustrates exemplary Satellite (SAT) AN 504 and SAT Ground Station (GND) 505 in wireless communication network 500 that authorizes user applications 521-523 to use wireless network slices 507-509. SAT AN 504 and SAT GND 505 comprise an example of communication system 124 and wireless communication network 411, although system 124 and network 411 may differ. SAT AN 504 comprises UE radio 901, ground radio 902, and processing circuitry 903. SAT GND 505 comprises satellite radio 904 and processing circuitry 905. Radios 901-902 and 904 comprise antennas, amplifiers, filters, modulation, analog-to-digital interfaces, DSPs, memories, transceivers, and power supplies that are coupled over bus circuitry. Processing circuitry 903 and 905 comprise one or more CPUs, one or more memories, and one or more transceivers that are coupled over bus circuitry. The one or more memories in processing circuitry 903 and 905 store software like an Operating System (OS), Satellite Application (SAT), and IP Application (IP). The antennas in UE radio 901 exchange satellite signals with UEs 501. Transceivers in UE radio 901 are coupled to transceivers in processing circuitry 903. Transceivers in processing circuitry 903 are coupled to transceivers in ground radio 902. The antennas in ground radio 902 exchange satellite signals with antennas in satellite radio 904, and the antennas in satellite radio 904 exchange the satellite signals with ground radio 902. Transceivers in satellite radio 904 are coupled to transceivers in processing circuitry 905. Transceivers in processing circuitry 905 are coupled to transceivers in NFVI 506. In processing circuitry 903 and 905, the one or more CPUs retrieve the software from the one or more memories and execute the software to exchange data and signaling between UEs 501 and NFVI 506 as described herein. In particular, the SAT and/or IP applications may receive application indicators from NFVI 506 and filter out user application data that is missing the proper application indicators.

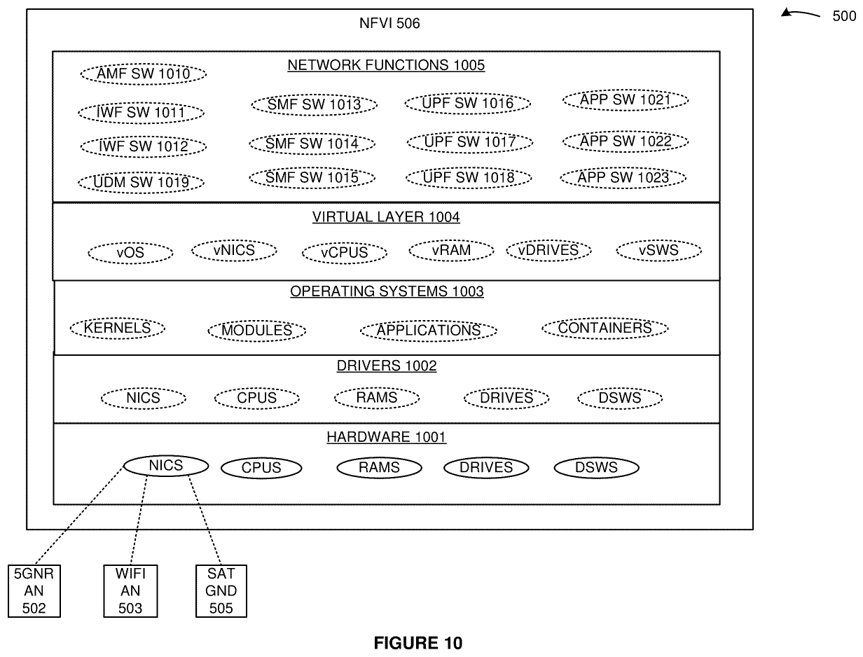

FIG. 10 illustrates exemplary Network Function Virtualization Infrastructure (NFVI) 506 in wireless communication network 500 that authorizes user applications 521-523 to use the wireless network slices 507-509. NFVI 506 comprises an example of slices 121-122, systems 123-124, wireless communication network 411, and edge computer 421, although slices 121-122, systems 122-123, network 411, and computer 421 may differ. NFVI 506 comprises hardware 1001, hardware drivers 1002, operating systems 1003, virtual layer 1004, and network functions 1005. Hardware 1001 comprises Network Interface Cards (NICS), TPMs, CPUs, RAM, Flash/Disk Drives (DRIVES), and Data Switches (DSWS). Hardware drivers 1002 comprise software that is resident in the NICS, TPMs, CPUs, RAM, DRIVES, and DSWS. Operating systems 1003 comprise kernels, modules, applications, and containers. Virtual layer 1004 comprises virtual Operating Systems (vOS), vNICS, vCPUS, vRAM, vDRIVES, and vSWS. Network Functions 1005 comprises AMF SW 1010, IWF SW 1011-1012, SMF SW 1013-1015, UPF SW 1016-1018, and UDM SW 1019. The NICS in hardware 1001 are coupled to ANs 502-503, SAT GND 505, and external systems. Hardware 1001 executes hardware drivers 1002, operating systems 1003, virtual layer 1004, and network functions 1005 to form and operate AMF 510, IWFs 511-512, SMFs 513-515, UPFs 516-518, and UDM 519 as described herein. NFVI 506 may be located at a single site or be distributed across multiple geographic areas. In particular, AMF SW 1010 and/or SMF SW 1013-1015 may authorize user applications and provide corresponding application identifiers. IWF SW 1011-1012 and UPF SW 1016-1018 may filter user application data based on the application indicators.

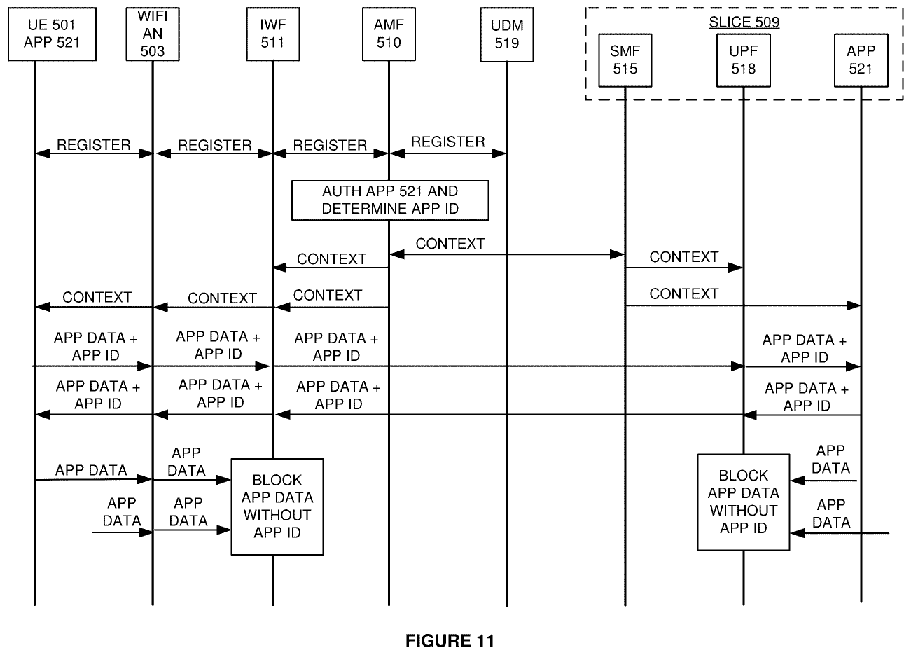

FIG. 11 illustrates an exemplary operation of wireless communication network 500 to serve distributed user application 521 using wireless network slice 509. The operation may differ in other examples. User application 521 is distributed between UE 501 and slice 509. UE 501 registers with AMF 510 over WIFI AN 503 and IWF 511, and AMF 510 retrieves subscriber information from UDM 519 during this process. AMF 501 authenticates UE 501 and does not provide non-emergency services until authentication is successful. After authentication, UE 501 may request user application 521 and slice 509, and/or the subscriber information may indicate user application 521 and slice 509. AMF 510 selects SMF 515 for slice 509, and AMF 510 and SMF 515 interact to develop UE context for user application 521 like network addresses and service quality. AMF 510 also determines an application indicator for user application 521 and slice 509 like a session code and the network addresses. AMF 510 adds the application indicator to the UE context. SMF transfers the UE context to UPF 518 and to user application 521. AMF 510 transfers the UE context to IWF 511. AMF 510 transfers the UE context to UE 501 over IWF 511 and WIFI AN 503. UE 501 adds the application indicator for user application 521 to application data from user application 521. UE 501 transfers the application data to IWF 511 over WIFI AN 503. Since this application data has the appropriate application indicator, IWF 511 transfers the application data to UPF 518 in slice 509. UPF 518 transfers the application data to user application 521 in slice 509. In slice 509, user application 521 adds the application indicator for user application 521 to application data for UE 501 and transfers the application data to UPF 518. Since the user data has the appropriate application indicator for the network address of UE 501, UPF 518 transfers the application data to UE 501 over IWF 511 and WIFI AN 503. When UPF 518 receives application data that does not have the proper application indicator, then UPF 518 does not transfer the application data to IWF 511. When 5GNR AN 502 receives application data that does not have the proper application indicator, then 5GNR AN 502 does not transfer the application data to UPF 517. When IWF 511 receives application data that does not have the proper application indicator, IWF 511 does not transfer the application data to UPF 518.

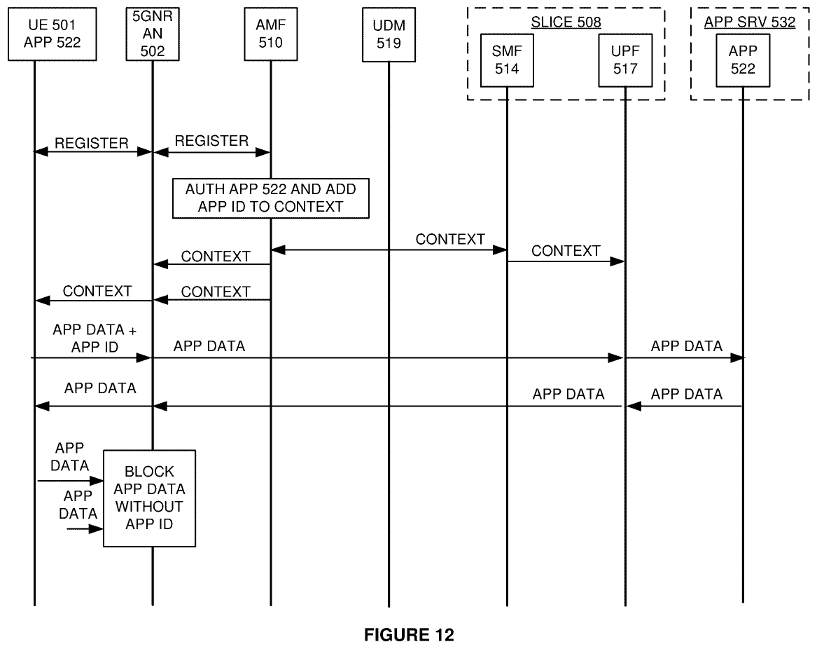

FIG. 12 illustrates an exemplary operation of wireless communication network 500 to couple user application 522 to application server 532 over wireless network slice 508. The operation may differ in other examples. In UE 501, user application 522 has a digital certificate for access to slice 508. UE 501 registers with AMF 510 over 5GNR AN 502 and includes the digital certificate from user application 522. AMF 510 decodes the digital certificate to select slice 508 and SMF 514. In some examples, the valid digital certificate serves as the authentication for UE 501. AMF 510 and SMF 514 interact to develop UE context for user application 522 like network addresses and service quality. AMF 510 also determines an application indicator for user application 522 and slice 508 like a session code and the network addresses. AMF 510 adds the application indicator to the UE context. SMF 514 transfers the UE context to UPF 517. AMF 510 transfers the UE context to 5GNR AN 502. AMF 510 transfers the UE context to UE 501 over 5GNR AN 502. UE 501 adds the application indicator for user application 522 to application data from user application 522. UE 501 transfers the application data to 5GNR AN 502. Since this application data has the appropriate application indicator, 5GNR AN 502 transfers the application data to UPF 517 in slice 508. UPF 517 transfers the application data to user application 522 application server 532. In application server 532, user application 522 transfers application data to UE 501 over UPF 517 and 5GNR AN 502. When 5GNR AN 502 receives application data that does not have the proper application indicator, 5GNR AN 502 does not transfer the application data to UPF 517. Application server 532 does not use the application indicator in this example.

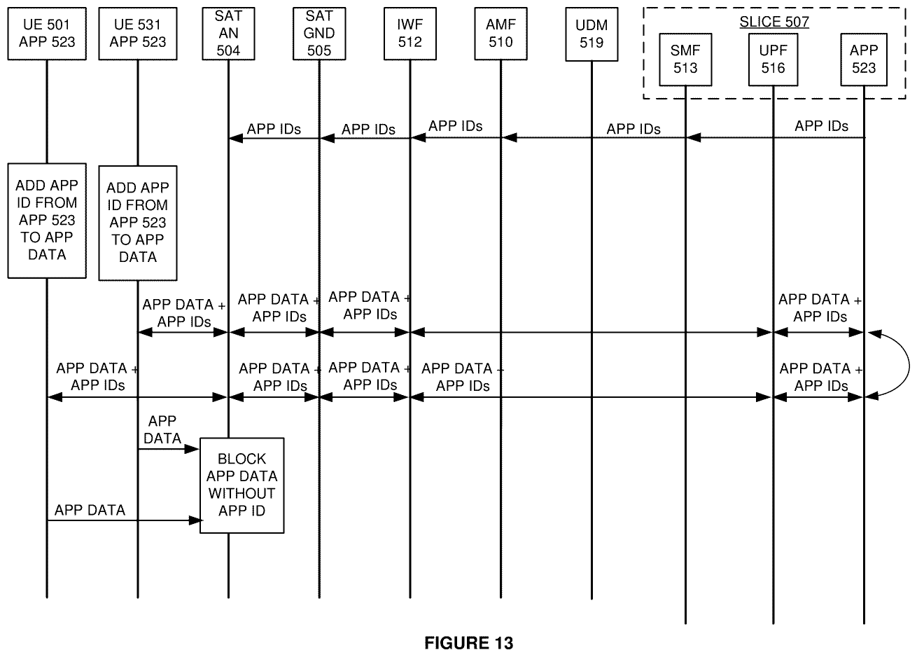

FIG. 13 illustrates an exemplary operation of wireless communication network 500 to couple distributed user application 523 in UE 501 and UE 531 with distributed user application 523 in wireless network slice 507. The operation may differ in other examples. User application 523 is distributed in UE 501, UE 531, and slice 507. In slice 507, user application 523 transfers its application indicators to SMF 513 which transfers the application indicators to AMF 510. In this example, the application indicators comprises temporary codes for user application 523. AMF 510 transfers the temporary codes to SAT AN 504 over IWF 512 and SAT GND 505. In UE 501, user application 523 is configured with one of the temporary codes—perhaps receiving it from user application 523 in slice 507 during a prior session. In UE 531, user application 523 is configured with another one of the temporary codes—perhaps receiving it from user application 523 in slice 507 during a prior session. UE 501 and UE 531 connect with SAT AN 504 and transfer their user application data that has their temporary codes. SAT AN 503 detects temporary codes, and in response, transfers the user application data to user application 523 in slice 507 over SAT GND 505, IWF 512, and UPF 516. Distributed user application 523 now executes in UE 501, UE 531, and slice 507 over these two satellite links. Distributed user application 523 in slice 507 issues new temporary codes to AMF 510, UE 501, and UE 531 for subsequent communication links.

Advantageously, wireless communication network 500 efficiently authorizes user applications 521-523 to use wireless network slices 507-509. Moreover, wireless communication network 500 effectively links user applications 521-523 with wireless network slices 507-509 without necessarily requiring the subscriber profile for UE 501 and UE 531—although UE authentication and slice authorization based on the subscriber profile may be used.

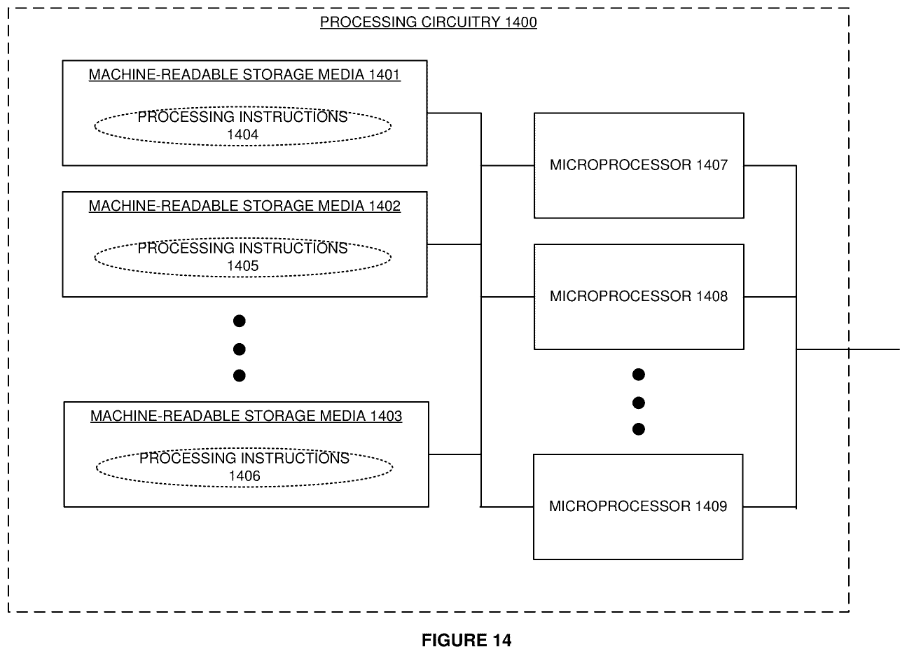

FIG. 14 illustrates exemplary processing circuitry to authorize a user application to use a network slice. Processing circuitry 1400 comprises an example of data system 100, wireless data system 400, and wireless communication network 500, although system 100, system 400, and network 500 may differ. Processing circuitry 1400 comprises machine-readable storage media 1401-1403 and microprocessors 1407-1409 that are communicatively coupled. Machine-readable storage media 1401-1403 store processing instructions 1404-1406 in a non-transitory manner. Microprocessors 1407-1409 comprise DSPs, CPUs, GPUs, ASICs, and/or some other data processing hardware. Machine-readable storage media 1401-1403 comprises RAM, flash circuitry, disk drives, and/or some other type of data storage apparatus. Microprocessors 1407-1409 retrieve processing instructions 1404-1406 from non-transitory machine-readable storage media 1401-1403. Microprocessors 1407-1409 execute processing instructions 1404-1406 to authorize user applications for network slices as described above for data system 100 and as described below for wireless communication network 500. The amount of storage media, microprocessors, processing instructions that are shown in FIG. 14 may vary in other examples.

The wireless communication system circuitry described above comprises computer hardware and software that form special-purpose data communication circuitry to authorize a user application to use a network slice. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose data communication circuitry to authorize a user application to use a network slice.

The included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

What is claimed is:

1. A method comprising:
authorizing a user application to use a data communication slice;
determining an application indicator for the user application in response to the authorization;
exchanging user application data having the user application indicator between a user device and the data communication slice based on the application indicator in the user application data; and
inhibiting other exchanges of other application data between the user device and the data communication slice that does not have the application indicator.

2. The method of claim 1 further comprising:
authenticating the user device; and wherein
exchanging the user application data between the user device and the data communication slice based on the application indicator comprises exchanging the user application data between the user device and the data communication slice based on the application indicator and in response to the authentication of the user device.

3. The method of claim 1 further comprising:
authenticating the user device and the user application; and wherein
exchanging the user application data between the user device and the data communication slice based on the application indicator comprises exchanging the user application data between the user device and the data communication slice based on the application indicator and in response to the authentication of the user device and the authentication of the user application.

4. The method of claim 1 wherein:
authenticating the user application; and
exchanging the user application data between the user device and the data communication slice based on the application indicator comprises associating the application identifier with the authentication of the user application.

5. The method of claim 1 wherein:
the application indicator comprises a Uniform Resource Indicator (URI); and
exchanging the user application data between the user device and the data communication slice based on the application indicator comprises exchanging the user application data between the user device and the data communication slice based on the URI.

6. The method of claim 1 wherein:
the application indicator comprises Internet Protocol (IP) address information; and
exchanging the user application data between the user device and the data communication slice based on the application indicator comprises exchanging the user application data between the user device and the data communication slice based on the IP address information.

7. The method of claim 1 further comprising generating charging information for usage of the user application based on the exchange of the user application data.

8. The method of claim 1 further comprising:
receiving an Application Programming Interface (API) call for the user application from a user application system, and in response, transferring authentication information for the user application to the user application system; and wherein
the user application system adds the authentication information to the user application; and
authorizing the user application to use the data communication slice comprises authenticating the user application based on the authentication information in the user application.

9. A wireless communication device comprising:
a device processing system to authenticate a user application, and in response, determine a user application indicator for the user application;
a wireless communication system to add the application indicator to user application data for the user application in response to the authentication;
the wireless communication system to exchange the user application data with a wireless network slice based on the application indicator in the user application data; and
the wireless communication system to inhibit exchanges of other application data with the wireless network slice when the other application data does not have the application indicator.

10. The wireless communication device of claim 9 wherein the wireless communication system comprises a Media Access Control (MAC).

11. The wireless communication device of claim 9 wherein the device processing system comprises a Radio Resource Control (RRC).

12. The wireless communication device of claim 9 wherein the device processing system is to validate a digital certificate in the user application to authenticate the user application.

13. A data system comprising:
a control system to authorize a user application to use a data communication slice;
the control system to determine a user application indicator for the user application;
a communication system to exchange user application data for the user application between a user device and the data communication slice based on the application indicator in the user application data; and
the data communication slice to process the user application data.

14. The data system of claim 13 further comprising:
the control system to authenticate the user device; and wherein
the communication system is to exchange the user application data between the user device and the data communication slice based on the application indicator and in response to the authentication of the user device.

15. The data system of claim 13 further comprising:
the control system to authenticate the user device and the user application; and wherein
the communication system is to exchange the user application data between the user device and the data communication slice based on the application indicator and in response to the authentication of the user device and the authentication of the user application.

16. The data system of claim 13 further comprising:
the control system to authenticate the user application and associate the application identifier with the authentication of the user application; and wherein
the communication system is to exchange the user application data between the user device and the data communication slice based on the association of the application identifier with the authentication of the user application.

17. The data system of claim 13 further comprising:
the application indicator comprises a Uniform Resource Indicator (URI); and
the communication system is to exchange the user application data between the user device and the data communication slice based on the URI.

18. The data system of claim 13 further comprising:
the application indicator comprises Internet Protocol (IP) address information; and
the communication system is to exchange the user application data between the user device and the data communication slice based on the IP address information.

19. The data system of claim 13 further comprising:
the communication system is to generate usage data for the exchange of the user application data; and
the control system is to generate charging information for usage of the user application based on the usage data.

20. The data system of claim 13 further comprising:
the control system is to receive an Application Programming Interface (API) call for the user application from a user application system, and in response, transfer authentication information for the user application to the user application system; and wherein
the user application system adds the authentication information to the user application; and
the control system is to authorize the user application to use the data communication slice based on the authentication information in the user application.
